(19) United States
(12) Patent Application Publication
(10) Pub. No.: US 2024/0375122 A1
(43) Pub. Date: Nov. 14, 2024

(54) APPARATUS AND METHOD FOR REAGENTIZING AND AERATING FEED TO FLOTATION MACHINES

(71) Applicant: FLSmidth A/S, Valby (DK)

(72) Inventors: Jacob Parrott, Midvale, UT (US); Lance Christodoulou, South Jordan, UT (US); Bartosz Dabrowski, Sandy, PA (US)

(21) Appl. No.: 18/292,920

(22) PCT Filed: Jul. 28, 2022
(86) PCT No.: PCT/IB2022/056995

§ 371 Date: Jan. 28, 2024

Related U.S. Application Data
(60) Provisional application No. 63/226,174, filed on Jul. 28, 2021.

(51) Int. Cl. B03D 1/14; B03D 1/02; B03D 1/24

(52) U.S. Cl. CPC B03D 1/145; B03D 1/028; B03D 1/1481; B03D 1/242

(57) ABSTRACT

A flotation circuit (1) is characterised in that it comprises a sparger (8) having a sparging mix conduit or chamber (45); and a tube (31) comprising a flexible perforated membrane disposed within the sparging mix conduit or chamber (45). The tube (31) is configured to receive an aerated fluid (27) comprising a combination of sparger water (13), reagent (17), and sparger air or gas (21) therein, shear the aerated fluid (27) upon passing of the aerated fluid (27) through the flexible perforated membrane of the tube (31), and disperse sheared aerated fluid (27) into the sparging mix conduit or chamber (45) where it is combined with incoming feed slurry (2) or diluted incoming feed slurry (4) moving within the sparging mix conduit or chamber (45) to form reagentized aerated slurry (29) for feeding a flotation apparatus (30).

### FIELD OF THE INVENTION

Embodiments of the present invention pertain to improvements to flotation machines, in particular, rotorless gravity- and/or inverted fluidized bed-assisted flotation apparatus. In particular, embodiments of the present invention relate to a unique flexible perforated membrane sparger for optimizing bubble size distributions to/within an infeed slurry and/or enabling periodic sparger purging. Moreover, embodiments include a method of dual-shearing of aerated fluids comprising liquid and reagent.

### BACKGROUND OF THE INVENTION

Reference to background art herein is not to be construed as an admission that such art constitutes common general knowledge in the arts.

In many industrial processes, fluidized beds may be used to suspend solids and perform various separations within equipment. These separations may be made using flotation techniques. For example, separations may be made by particle minerology, composition, density, and/or hydrophobicity. Examples of such devices can be found in WO 2011/150455 A1, where incoming slurry passes downwardly into a separation chamber forming an inverted fluidized bed. FIGS. 2 and 4 of WO 2011150455 A1 suggest that a solid porous sparger may be used to entrain air into feed slurry entering a separation device capable of flotation.

It would be desirable to provide self-cleaning functionality to such flotation spargers, improve flotation efficiency, increase hydrophobicity of target minerals within feed particles, and increase particle-bubble contact.

Embodiments of the present invention aim to improve upon existing inverted fluidized bed flotation machines by incorporating low-cost structures which synergistically work together to provide a more homogeneous bubble size distribution, more uniform introductions of aerated fluids to incoming feed, and improved recovery.

### OBJECTS OF THE INVENTION

It is an aim that embodiments of the invention provide an improved flotation gravity-assisted flotation apparatus which overcomes or ameliorates one or more of the disadvantages or problems described above, or which at least provides a useful alternative to related conventional apparatus.

An aim of some embodiments of the invention may include providing an improved flotation machine which is equipped to entrain much finer bubble sizes within its slurry feed, without limitation.

An aim of some embodiments of the invention may include providing an improved flotation machine which is equipped to perform periodic self-cleaning on spargers therein, without limitation.

An aim of some embodiments of the invention may include providing an improved manner in which feed slurry is prepared prior to entering a flotation machine, without limitation.

An aim of some embodiments of the invention may include providing an improved flotation machine which is configured to optimize and/or better control bubble size/mineral attachment at a sparger therein, while simultaneously maintaining a feed density setpoint and water balance, without limitation.

It should be understood that not every embodiment may be configured to obtain each and every one of the abovementioned objects. However, specific embodiments may demonstrate the ability to achieve or satisfy at least one or more of the abovementioned goals.

Other preferred objects of the present invention will become apparent from the following description.

### SUMMARY OF INVENTION

According to embodiments of the invention, a flotation feed system or circuit (1) is disclosed.

The flotation circuit (1) may comprise a flotation apparatus (30). The flotation apparatus (30) may comprise feed introduction means. The feed introduction means may be located at an upper region or a lower region of the flotation apparatus (30). The feed introduction means may be configured to deliver feed material into a main separation chamber (32) of the flotation apparatus (30). The flotation apparatus (30) may be configured to allow particles of the feed material entering the main separation chamber (32) to leave the flotation apparatus (30) through an upper outlet (39) of the flotation apparatus (30) or through a lower outlet (39) of the flotation apparatus (30), without limitation.

The flotation circuit (1) may be characterized in that it comprises a sparger (8) having a sparging mix conduit or chamber (45) and at least one tube (31) comprising a flexible perforated membrane. The tube (31) is preferably disposed within the sparging mix conduit or chamber (45). The tube (31) preferably comprises a flexible perforated membrane.

The tube (31) is preferably configured to receive an aerated fluid (27) comprising a combination of sparger water (13), reagent (17), and sparger air or gas (21) therein. The combination of sparger water (13), reagent (17), and sparger air or gas (21) may be combined in a mixer (25).

The tube (31) is also preferably configured to shear said aerated fluid (27) upon passing of the aerated fluid (27) through the flexible perforated membrane of the tube (31) (e.g., from an inner region of the tube (31) to an outer region surrounding the tube (31), without limitation). The tube (31) is also preferably configured to disperse the sheared aerated fluid (27) into the sparging mix conduit or chamber (45) such that the sheared aerated fluid (27) combines with the feed material (4) moving within the sparging mix conduit or chamber (45).

Reagentized aerated slurry (29) comprising a combination of i) the feed material (4) and ii) sheared aerated fluid (27) may be introduced to the main separation chamber (32) of the flotation apparatus (30).

In some embodiments, the tube (31) of the sparger (8) may be configured as one of the group consisting of: a straight tube, a curved tube, a coil, a disc, a puck, a panel, and a plate, without limitation.

In some embodiments, the sparger (8) may comprise a plurality of sparging mix conduits or chambers (45). Each of the sparging mix conduits or chambers (45) may have a tube (31) comprising a flexible perforated membrane therein, without limitation.

In some embodiments, the flotation circuit (1) may comprise a source of sparger water (13), a source of reagent (17), and a source of sparger air or gas (21), without limitation.

The flotation circuit (1) may be configured such that each source (of sparger water (13), reagent (17), and sparger air or gas (21)) is accompanied by its own flow meter (14, 18, 22) and control valve (15, 19, 23) in order to control and/or adjust relative amounts of sparger water (13), reagent (17), and sparger air or gas (21) to a mixer (25) before the resulting aerated fluid (27) is introduced to the sparger (8).

In some embodiments, the mixer (25) may be configured to feed the aerated fluid (27) to an inner portion of the tube (31) of the sparger (8). A check valve (26) may be provided between the mixer (25) and sparger (8), without limitation.

One or more of the flow meters (10, 14, 18, 22) and/or control valves (11, 15, 19, 23) may be configured to communicate with a distributed control system (DCS) (25) over a bus or network (12).

The tube (31) may be disposed within the sparging mix conduit or chamber (45). Where multiple sparging mix conduits or chambers (45) are employed, each sparging mix conduit or chamber (45) may be equipped with at least one tube (31) therein, without limitation. In some embodiments, multiple tubes (31) may be provided to a sparging mix conduit or chamber (45), without limitation.

In some embodiments, a pulping tank (3) configured for diluting incoming feed slurry (2) and delivering diluted incoming feed slurry (4) to the sparger (8) as feed material may be provided to the flotation circuit (1). To accommodate dilution of incoming feed slurry (2), the flotation circuit (1) may comprise a source of dilution water (9). A flow meter (10) may be provided downstream of the source of dilution water (9). A control valve (11) may be provided downstream of the source of dilution water (9). The control valve (11) may be configured to control and/or adjust the amount of the dilution water (9) being provided to the pulping tank (3).

The flow meter (10) and control valve (11) may be configured to communicate with a distributed control system (DCS) (25) over a bus or network (12). The distributed control system (DCS) (25) may be configured to control and/or adjust the amount of dilution water (9) being added to the incoming feed slurry (2) in a manner which compensates for an amount of the sparger water (13) being introduced to the sparger (8) (e.g., by way of the aerated fluid (27)). The distributed control system (DCS) (25) may be configured to control and/or adjust the amount of dilution water (9) being added to the incoming feed slurry (2) in a manner which ensures proper water balance of the feed material to the flotation apparatus (30), without limitation.

For example, the distributed control system (DCS) (25) may be configured to control and/or adjust the amount of dilution water (9) being added to the incoming feed slurry (2) in a manner which ensures proper water balance of the reagentized aerated slurry (29) being introduced to the flotation apparatus (30), without limitation.

The sparger (8), in some embodiments, may comprise a plurality of tubes (31) within the sparging mix conduit or chamber (45), without limitation. In such embodiments, each of the plurality of tubes (31) may comprise a flexible perforated membrane.

In some embodiments, the flotation apparatus (30) may comprise a column flotation cell. In some embodiments, the flotation apparatus (30) may comprise a flotation cell comprising a lamella section (33); for example, a flotation apparatus (30) which is capable of forming an inverted fluidized bed within the main separation chamber (32).

In some embodiments of the flotation circuit (1), the flotation apparatus (30) may comprise the sparger (8). For example, the sparger (8) may be an integral component of the flotation apparatus (30). In some embodiments of the flotation circuit (1), the sparger (8) may be provided upstream of the flotation apparatus (30) within the circuit. For example, the sparger (8) may be a component which is separate from or non-integral with the flotation apparatus (30) (e.g., an upstream “sparger box” as depicted in FIG. 5, without limitation).

A method for performing flotation is also disclosed. The method may comprise the step of providing a flotation circuit (1) as described above. The method may comprise the step of conveying the feed material (4) (e.g., incoming feed slurry (2) or diluted incoming feed slurry) through the sparging mix conduit or chamber (45) of the sparger (8).

The method may comprise the step of mixing an amount of the sparger water (13), reagent (17), and sparger air or gas (21) together (e.g., in a mixer (25)) to form an aerated fluid (27). The method may comprise the step of delivering the aerated fluid (27) to the tube (31) of the sparger (8). For example, the aerated fluid (27) may be provided to an inner portion of the tube (31) and expelled through the flexible perforated membrane and into the sparging mix conduit or chamber (45), without limitation.

The method may comprise the step of shearing the aerated fluid (27), for example, by virtue of passing the aerated fluid (27) through the flexible perforated membrane and into the sparging mix conduit or chamber (45), without limitation. The method may comprise the step of combining the sheared aerated fluid (27) and the feed material (4) in the sparging mix conduit or chamber (45) to form a reagentized aerated slurry (29). The method may comprise the step of conveying the reagentized aerated slurry (29) to the flotation apparatus (30) and/or introducing the reagentized aerated slurry (29) to the main separation chamber (32) of the flotation apparatus (30), without limitation.

In some embodiments, the method may involve the step of diluting incoming feed slurry (2) to form diluted incoming feed slurry (4). In such embodiments, the method may include the step of conveying the diluted incoming feed slurry (4) to the sparger (8) as the feed material thereto.

Further features and advantages of the present invention will become apparent from the following detailed description.

### BRIEF DESCRIPTION OF THE DRAWINGS

By way of example only, preferred embodiments of the invention will be described more fully hereinafter with reference to the accompanying figures. It will be appreciated from the drawings that some of FIGS. 1-4 may intentionally omit features or hide components for clarity and/or better visualization and understanding of the invention. Moreover, for clarity, where there are a plurality of similar features in a particular figure, only one of the features may be labelled with reference numerals.

FIG. 1 is a schematic representation of a novel and heretofore unobvious flotation circuit (1) incorporating novel structures, novel structural relationships, novel sparging apparatus, and/or novel method steps pertaining to aerating and reagentizing a slurry feed material (4) for provision of a reagentized aerated slurry (29) to a flotation apparatus (30) according to some embodiments. In this particular embodiment, a sparger (8) forms an integral portion of the flotation apparatus (30) and is contained within the flotation apparatus (30).

FIG. 2 is an isometric representative view illustrating an embodiment of a sparger (8) which may be used to provide reagentized and aerated slurry (29) to a flotation apparatus (30).

FIG. 3 is a top plan view of the sparger (8) device shown in FIG. 2.

FIG. 4 shows a schematic side cutaway view representation of the sparger (8) depicted in FIGS. 2 and 3.

FIG. 5 is a schematic representation of another embodiment of a flotation circuit (1) in accordance with the invention, wherein a sparger (8) is separate from, located upstream from, and/or forms a non-integral portion the flotation apparatus (30). For example, in contrast to FIG. 1, this particular embodiment depicts a sparger (8) being provided outside of the main separation chamber (32) of the flotation apparatus (30). The sparger (8) fluidly communicates with a downcomber (63) of the flotation apparatus (30) to feed the flotation apparatus (30) with reagentized aerated slurry (29).

FIG. 6 suggests yet another embodiment of a flotation circuit (1), depicting a sparger (8) comprising a plurality of sparging mix conduits or chambers (45), each comprising its own tube (31). For example, the sparger (8) shown in this figure may be of the type depicted in FIGS. 2-4, without limitation.

FIG. 7 depicts yet another embodiment of a flotation circuit (1), wherein the flotation apparatus (30) comprises a column flotation cell having a relatively slender main separation chamber (32) which extends vertically.

FIG. 8 suggests one possible sparger (8) arrangement which may be used in conjunction with the column flotation cell depicted in the flotation circuit (1) of FIG. 7.

FIG. 9 suggests another possible sparger (8) arrangement which may be used in conjunction with the column flotation cell depicted in the flotation circuit (1) of FIG. 7. In contrast to FIG. 8, FIG. 9 suggests that a single pump (5) may be utilized to convey feed material (4) to a plurality of sparging mix conduits or chambers (45), each having at least one tube (31) formed with a flexible perforated membrane. Aerated fluid (27) may be provided to each of the tubes (31). The feed material (4) may be conveyed to the plurality of spargers (8) via a manifold (64), without limitation.

FIG. 10 suggests an embodiment of a sparger (8) wherein a plurality of tubes (31) are provided to a single sparging mix conduit or chamber (45).

FIG. 11 suggests another embodiment of a sparger (8) wherein a plurality of tubes (31) are provided to a single sparging mix conduit or chamber (45).

### DETAILED DESCRIPTION OF THE DRAWINGS

A flotation system or circuit 1 (i.e., a flotation island, process, assembly, or apparatus) is disclosed. The flotation circuit 1 may receive incoming feed slurry 2, and comprise means for pulping the same. For example, the incoming feed slurry 2 may enter a pulping tank 3 which is configured to store the incoming feed slurry 2, and dilute it as necessary for a flotation operation. The pulping tank 3 may comprise some dilution water 9 which is provided to the tank 3 from a suitable source (e.g., spigot, process water holding tank, or the like).

The amount of dilution water 9 provided to the pulping tank 3 may be controlled and/or adjusted over time. A first flow meter 10 and a first control valve 11 may be provided to the circuit 1 to enhance these controls and adjustments. Data provided by the first flow meter 10 may be relayed via a bus or network 12 to a distributed control system (DCS) 28. The data received by the DCS may be used to provide control inputs to the first control valve 11. The DCS may be configured to ensure proper dilution of the incoming feed slurry 2 and/or proper water balance in the pulping tank 3. Signals between the aforementioned components (e.g., first flow meter 10, first control valve 11, and DCS 28) may be delivered and/or received via a hard-wired connection or a wireless network, without limitation.

Diluted incoming feed slurry 4 leaving the pulping tank may be conveyed to a (second) flow meter 6 and then to a density meter 7 using a pump 5. The pump 5 may be provided at any point between the tank 3 and a flotation apparatus 30 within the circuit 1, including, but not limited to between the second flow meter 6 and pulping tank 3 as shown. While one pump 5 is shown, a plurality of pumps 5 may be employed within the circuit 1.

The diluted incoming feed slurry 4 may be introduced to a sparger 8, where aerated fluid 27 (comprising a mixture of sparger water 13, flotation reagent 17, and sparger air/gas 21) can mix therewith. A fourth check valve 26 may be provided upstream of the sparger 8 as shown. The composition of the aerated fluid 27 to be mixed/entrained within the diluted incoming feed slurry 4 may be controlled upstream of a mixer 25 which combines the sparger water 13, flotation reagent 17, and sparger air/gas 21.

A source of sparger water 13 may be provided to the circuit 1 from a suitable source (e.g., spigot, process water holding tank, or the like). The amount of sparger water 13 provided to the mixer 25 may be controlled and/or adjusted over time. A third flow meter 14 and a second control valve 15 may be provided to the circuit 1 to enhance these controls and adjustments. Data provided by the third flow meter 14 may be relayed via the bus or network 12 to a distributed control system (DCS) 28. The data received by the DCS may be used to provide control inputs to the second control valve 15 via the bus or network 12. The DCS may be configured to ensure proper % or ratio of the sparger water 13 to the mixer 25. Signals between the aforementioned components (e.g., third flow meter 14, second control valve 15, and DCS 28) may be delivered and/or received via a hard-wired connection or a wireless network, without limitation. A first check valve 16 may be provided to the circuit 1, and the sparger water 13 may pass through the first check valve 16 after leaving the second control valve 15, without limitation.

A source of flotation reagent 17 may be provided to the circuit 1 from a suitable source (e.g., spigot, process water holding tank, or the like). The amount of reagent 17 provided to the mixer 25 may be controlled and/or adjusted over time. A fourth flow meter 18 and a third control valve 19 may be provided to the circuit 1 to enhance these controls and adjustments. Data provided by the fourth flow meter 18 may be relayed via the bus or network 12 to a distributed control system (DCS) 28. The data received by the DCS may be used to provide control inputs to the third control valve 19 via the bus or network 12. The DCS may be configured to ensure proper % or ratio of the reagent 17 to the mixer 25. Signals between the aforementioned components (e.g., fourth flow meter 18, third control valve 19, and DCS 28) may be delivered and/or received via a hard-wired connection or a wireless network, without limitation. A second check valve 20 may be provided to the circuit 1, and the reagent 17 may pass through the second check valve 20 after leaving the third control valve 19, without limitation.

A source of sparger air or gas 21 may be provided to the circuit 1 from a suitable source (e.g., an air line, hose, compressor, pneumatic reservoir, tank, or the like). The amount of sparger air or gas 21 provided to the mixer 25 may be controlled and/or adjusted over time. A fifth flow meter 22 and a fourth control valve 23 may be provided to the circuit 1 to enhance these controls and adjustments. Data provided by the fifth flow meter 22 may be relayed via the bus or network 12 to a distributed control system (DCS) 28. The data received by the DCS may be used to provide control inputs to the fourth control valve 23 via the bus or network 12. The DCS may be configured to ensure proper % or ratio of the sparger air or gas 21 to the mixer 25. Signals between the aforementioned components (e.g., fifth flow meter 22, fourth control valve 23, and DCS 28) may be delivered and/or received via a hard-wired connection or a wireless network, without limitation. A third check valve 24 may be provided to the circuit 1, and the sparger air or gas 21 may pass through the third check valve 24 after leaving the fourth control valve 23 without limitation.

The ratio of aerated fluid 27 to diluted incoming feed slurry 4 may be controlled using the sparger 8. While not shown, it is envisaged that another control valve may be provided downstream of the mixer 25, or the fourth check valve 26 may be replaced with a control valve, without limitation.

In any event, the aerated fluid 27 is provided within a tube 31 of the sparger 8, the tube 31 preferably comprises a flexible perforated (i.e., permeable) membrane having a number of holes, openings, slits, perforations, or apertures therethrough. The flexible perforated membrane is preferred to a solid, nonflexible porous tube because it allows for periodic overpressurization of the aerated fluid 27 within the tube 31 to functionally serve a self-cleaning function. In other words, should perforations through the permeable flexible membrane become occluded by particles within the diluted incoming feed slurry 4, the pressure within or the flow rate of aerated fluid 27 to inner portions of the tube 31 may be temporarily increased so as to expand the tube 31, increase the area of the perforations, and increase velocities of the aerated fluid 27 through the perforations of the tube's 31 flexible perforated membrane—thus, dislodging particles from surfaces/openings of the tube 31.

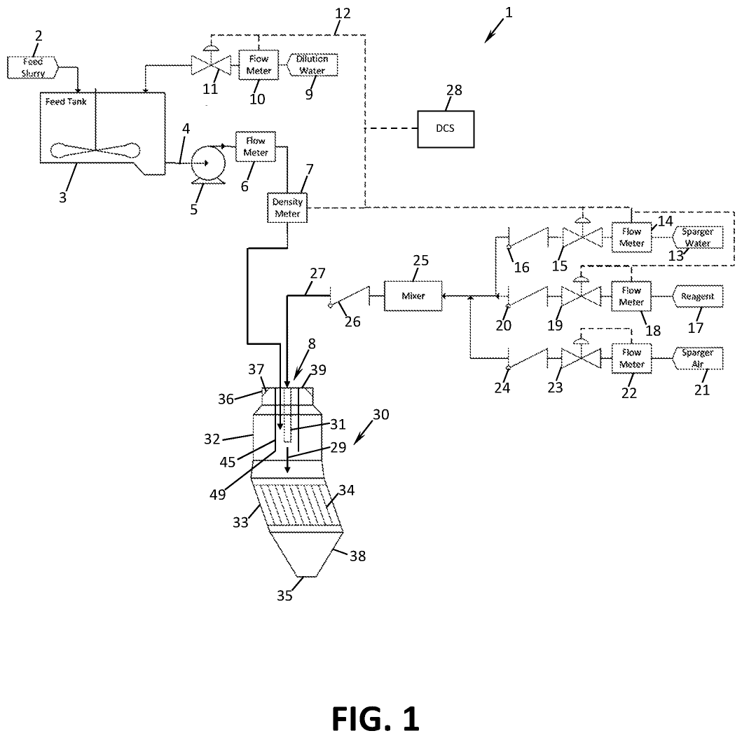

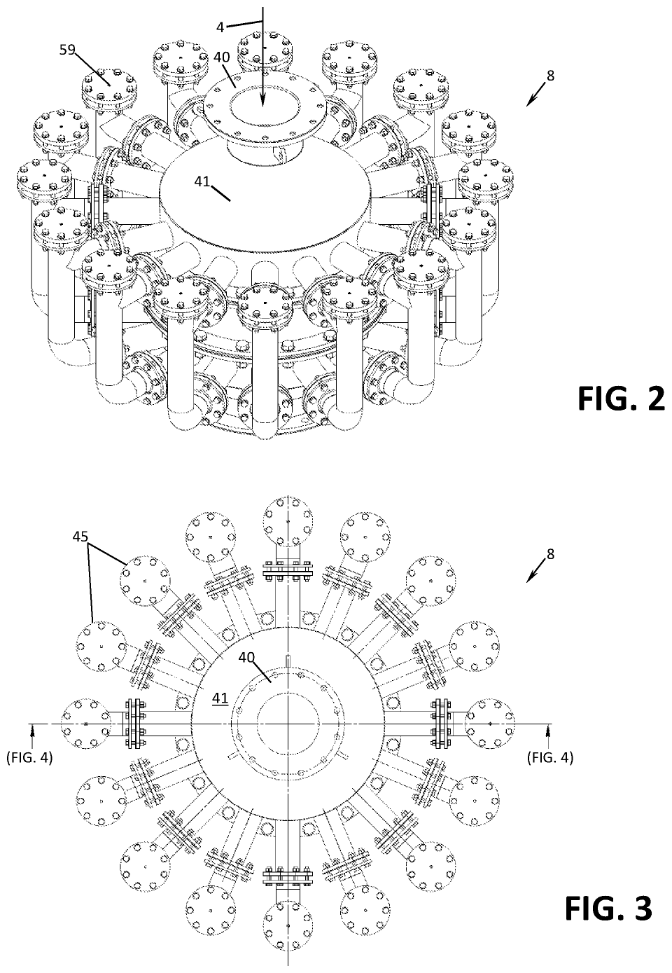

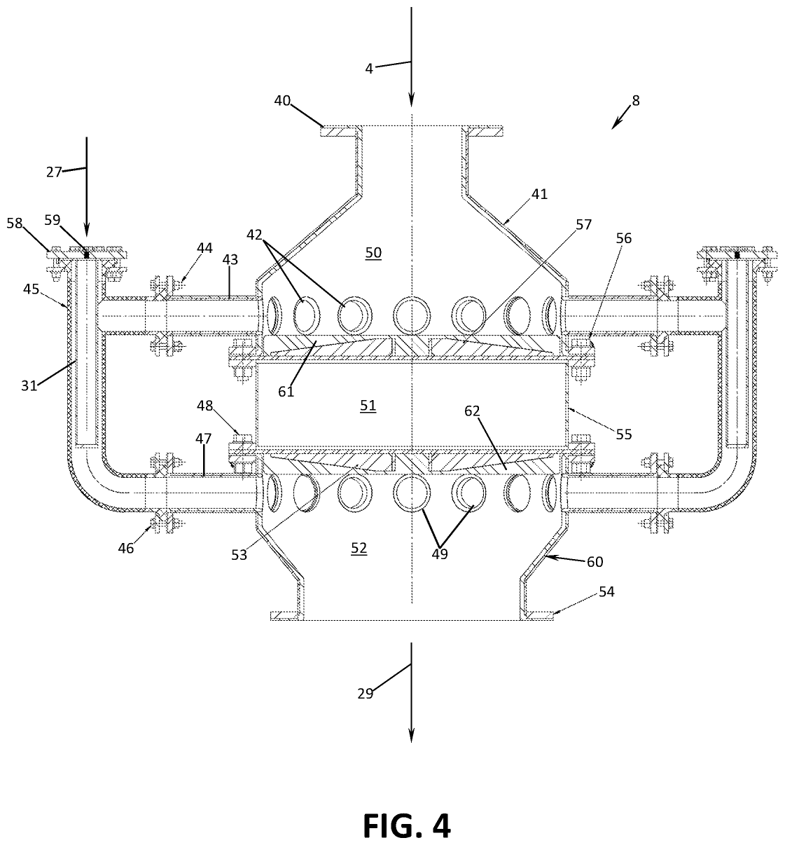

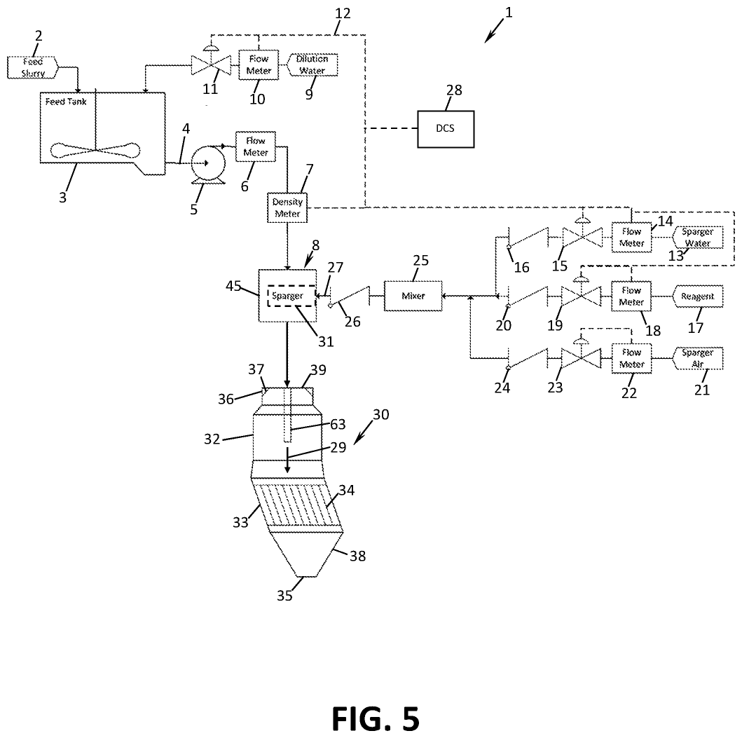

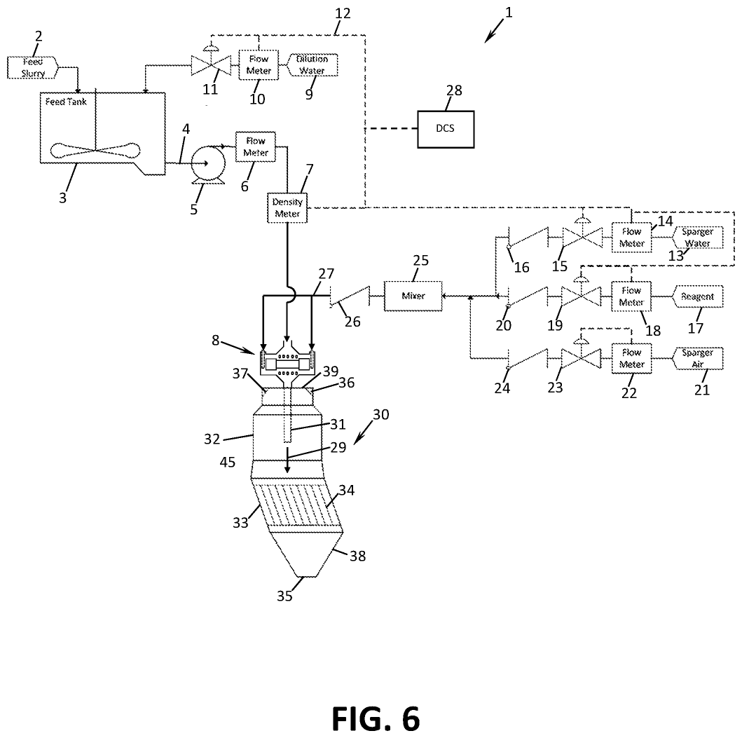

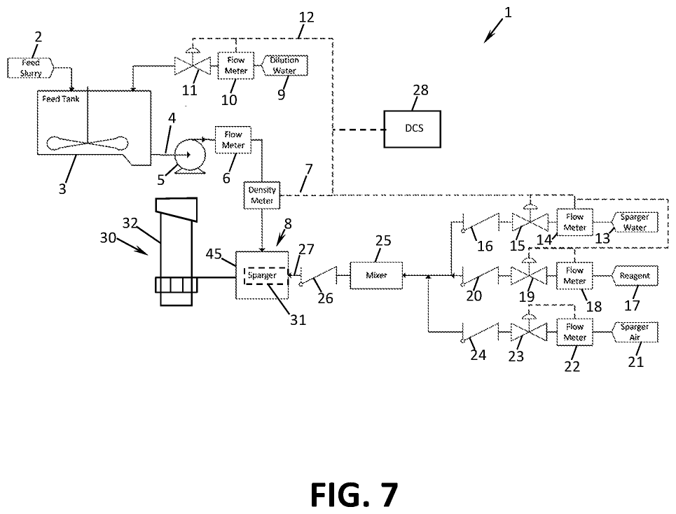

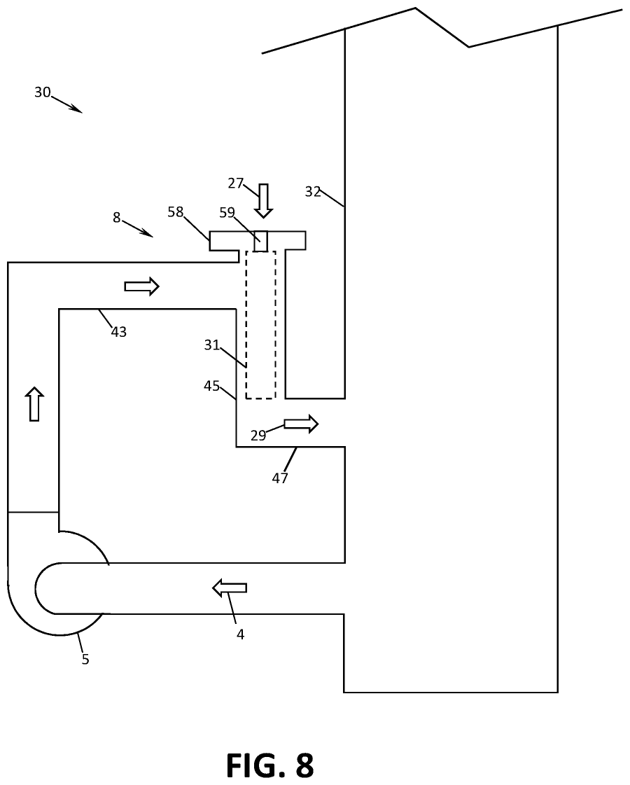

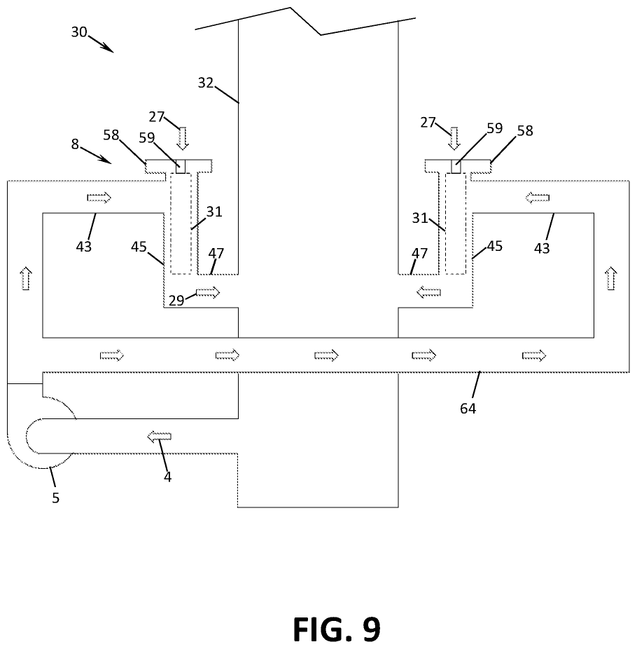

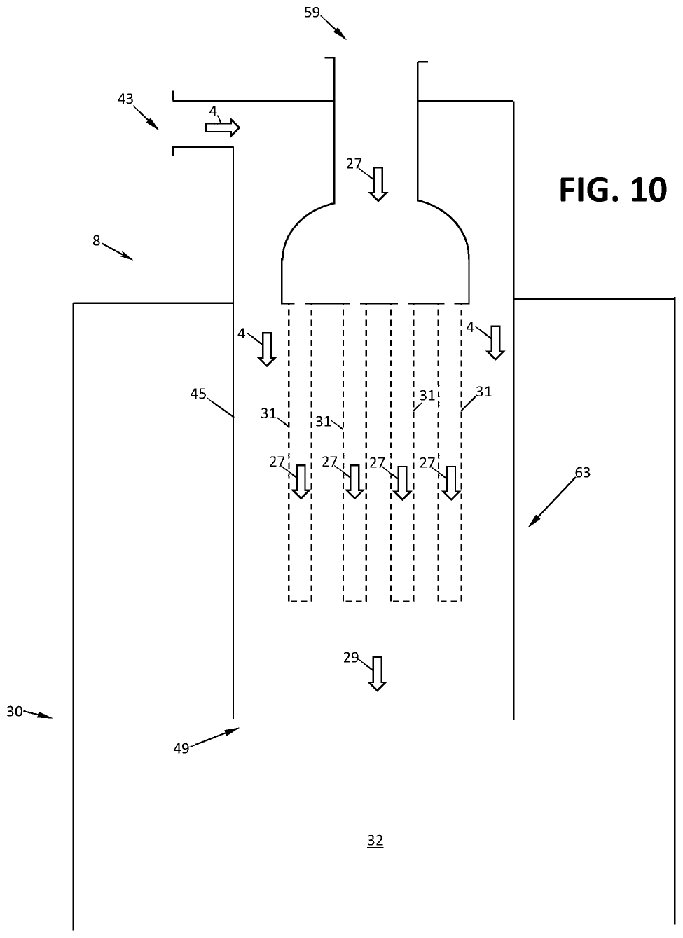

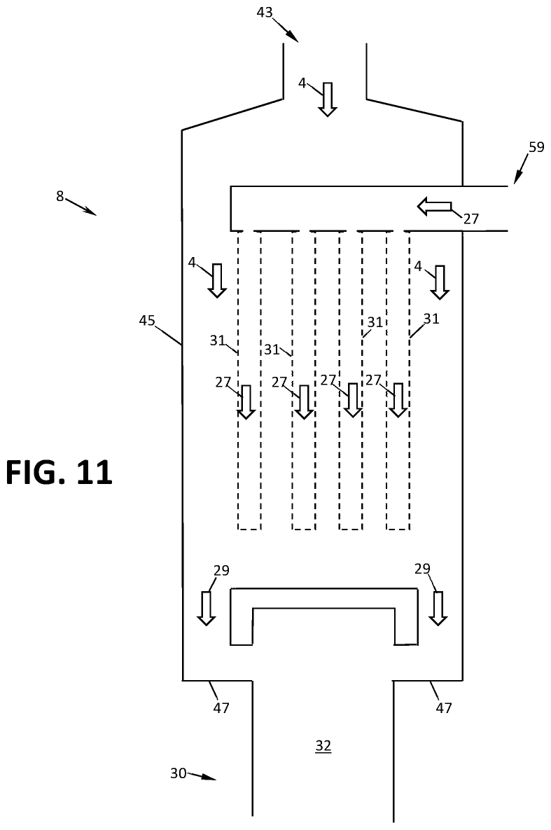

Prior to entering the flotation apparatus 30, the diluted incoming feed slurry 4 is introduced into one or more sparging mix conduits or chambers 45. As suggested in FIG. 1, a single sparging mix conduit or chamber 45 may be employed. As suggested in FIGS. 2-4, a plurality of sparging mix conduits or chambers 45 may be employed. At least one tube 31 having a flexible perforated membrane (as described above) is located within each sparging mix conduit or chamber 45. The aerated fluid 27 passes outwardly through the tube 31 and into its respective sparging mix conduit or chamber 45 where it mixes with the diluted incoming feed slurry 4. Thus, as the diluted incoming feed slurry 4 passes through the sparging mix conduit or chamber 45, it mixes with sheared aerated fluid 27 passing through the flexible perforated membrane. Said differently, the aerated fluid 27 is sheared as it passes through the tube 31, and becomes entrained within the diluted feed slurry 4 as the diluted feed slurry 4 passes through a sparging mix conduit or chamber 45.

Each sparging mix conduit or chamber 45 may comprise one or more lower outlet ports 49. As shown in the embodiment depicted by FIG. 1, a single lower outlet port 49 may be provided, wherein the lower outlet port 49 is defined by a lower end portion of the sparging mix conduit or chamber 45.

Reagentized aerated slurry 29 comprising a mixture of aerated fluid 27 and diluted incoming feed slurry flowing through a sparging mix conduit or chamber 45 may exit the sparging mix conduit or chamber 45 through the lower outlet port 49 and enter a main separation chamber 32 of the flotation apparatus 30. The Reagentized aerated slurry 29 may, as shown, flow downwardly into the main separation chamber 32 and towards a lamella section 33 comprising an inclined plate stack or series of lamella plates/lamellae 34. Gangue or unfloated particles may head downwardly to a lower section 38 and depart the flotation apparatus 30 through a lower outlet 35. Floated particles, e.g., those having a target mineral capable of binding with reagent 17 to make them hydrophobic, may head upward towards wash water introduction means 36 where they can be washed before exiting the apparatus 30 through an upper outlet 39.

Wash water introduction means 36 may comprise a wash water feeder or a chamber comprising wash water under pressure. The water introduction means 36 may comprise a lower plate 37 having one or more openings, apertures, nozzles, perforations, or the like therethrough which allow wash water to flow into upper regions of the main separation chamber 32.

Turning now to FIGS. 2-4, a sparger 8 for feeding a flotation apparatus 30 may be configured with an upper flange 40 for connecting to upstream components and a lower flange 54 for connecting to downstream components. Diluted incoming feed slurry 4 may enter through the upper flange 40 and into an upper housing 41 defining an upper chamber 50 where it may be subsequently distributed to a plurality of upper intake conduits 43 through a plurality of respective upper intake ports 42. Each upper intake conduit 43 may connect to a respective sparging mix conduit or chamber 45 via an upper flanged connection 44.

Feed material, such as diluted incoming feed slurry 4, may enter into a side portion of a respective sparging mix conduit or chamber 45 and flow to a lower intake conduit suitable for conveying reagentized aerated slurry 29 to the flotation apparatus 30. Within each sparging mix conduit or chamber 45 may be provided a tube 31 comprising a flexible perforated membrane. The tube(s) 31 may, as shown, each be aligned to extend generally parallel, coaxial, and/or substantially concentric with its surrounding respective sparging mix conduit or chamber 45. In this regard, the diluted incoming feed slurry 4 may flow through an annular passage defined between the tube 31 and the walls defining the sparging mix conduit or chamber 45. Aerated fluid 27 comprising sparger water 13, reagent 17, and sparger air or gas 21 may be delivered through an inlet opening 59 through an upper closed end 58 of each sparging mix conduit or chamber 45. The Aerated fluid 27 passes into its adjacent tube 31 and undergoes shearing as it exits the tube by passing through the flexible perforated membrane. Thus, the aerated fluid 27 mixes with the diluted incoming feed slurry 4 in the conduit 45 and a fine distribution of bubbles including sparger air/gas 21 and reagent 17 can become entrained within the diluted incoming feed slurry 4 forming reagentized aerated slurry 29.

The reagentized aerated slurry 29 comprising the mixture of diluted incoming feed slurry 4 and aerated fluid 27 may be introduced through one or more lower intake conduits 47 which may each be connected to its respective sparging mix conduit or chamber 45 via a lower flanged connection 46 as shown. The reagentized aerated slurry 29 may pass through one or more lower outlet ports 49 before entering a lower chamber 52 defined by a lower housing 60.

The sparger 8 may comprise, in some embodiments, an upper flow diverter 57 for diverting diluted incoming feed slurry 4 to the upper intake conduit(s) 43. The sparger 8 may comprise, in some embodiments, a lower flow diverter 53 for biasing reagentized aerated slurry 29 entering the lower chamber 52 out of the lower chamber 52 and through the lower flange 54 of the sparger 8. The sparger 8 may, in some embodiments, comprise a middle chamber 51 defined by a middle housing 55. The middle housing 55 may connect to the lower housing 60 via a lower connection flange 48, without limitation. The middle housing 55 may connect to the upper housing 41 via an upper connection flange 56, without limitation. The upper flow diverter 57 may be secured to a portion of the upper connection flange 56.

A portion of the upper flow diverter 57 may be provided with a sacrificial replaceable wear element 61 as shown. A portion of the lower flow diverter 53 may be provided with a sacrificial replaceable wear element 62 as shown.

The devices, structures, technical features, benefits, and/or method steps described and/or illustrated herein are provided merely as examples to which the invention of the claims may be applied. The specification does not suggest that the claims are somehow limited to or apply only to the particular embodiments shown and described herein.

The above description of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art in light of the above teaching(s). Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, as well as other embodiments that might clearly fall within the spirit and scope of the above described invention.

Where used herein, the term “perforated” or “perforations” may be broadly construed as a membrane having passages in which gas and/or liquid may pass. Thus, a “perforated” membrane, where used herein, may include a sheet (preferably flexible) with one or more slits having substantially zero width, one or more slots with minimal discernible width, one or more pin holes or pin pricks of substantially zero diameter, one or more pin holes or pin pricks with minimal discernible width, small substantially symmetrical openings (e.g., orifices), one or more small elongated openings, or the like, without limitation. For example, in some preferred embodiments, 1 mm spaced slits (±0.5 mm) may be applied to a membrane in a preferably uniform pattern, with the slits being formed with substantially no discernible width. In some preferred embodiments, approximately of such slits may be provided to the membrane per square inch of membrane, without limitation. It is anticipated that a greater or lesser number of perforations may be provided (e.g., 1 perforation per square inch to as much as 150 perforation per square inch, such as 50-150 perforations per square inch). The material properties of the membrane may ultimately determine the maximum number of slits that may be practically provided per square inch of membrane.

In some embodiments, the perforations in the membrane may comprise a combination of one or more: slits, pin holes, pin pricks, symmetrical openings, and/or elongated openings in any variation, number, combination, or pattern, but are preferably staggered and/or uniformly distributed across an area of the membrane. In some embodiments, the one or more slits, pin holes, pin pricks, symmetrical openings, and/or elongated openings may appear closed or form a normally-closed aperture (e.g., in an unstressed or unpressurized state), wherein upon an application of pressure or fluid flow force to the sparger, the same may open to allow passage or flow of a fluid such as gas and/or liquid through the membrane, without limitation. In this regard, a flexible perforated membrane sparger described herein may be configured for (or inherently comprise means for) backflow prevention, wherein fluids are able to pass from the sparger through the perforated flexible membrane structure (via the perforations), but solids may not necessarily be able to pass thereinto if the sparger is depressurized or membrane relaxed.

In some embodiments, the one or more slits, pin holes, pin pricks, symmetrical openings, and/or elongated openings defining the perforations in the membrane may have a maximum opening size width of 1 nanometer to 3 millimeters or more. For purposes of fine bubble size and optimal flotation characteristics, the inventors have determined that a maximum opening size width maintained at or below approximately 2 millimeters is preferred, without limitation.

Where used herein, the term “membrane” may comprise many different materials, including, but not limited to EPDM rubber, silicone rubber, santoprene, gum rubber, natural rubber, neoprene, and/or the like. Thicknesses may vary but are preferably greater than 1/16 of an inch (e.g., ⅛″ to ¼″), without limitation.

It should be understood that if perforations in the membrane happen to become clogged or scaled by solids during operation of the flotation apparatus 30, an over pressurization of aerated fluid 27 may be performed (continuously or periodically/intermittently) in order to open perforations and free/dislodge trapped solids therefrom by hydraulic force. Thus, a flexible perforated membrane sparger 8 described herein may be configured for (or inherently comprise means for) clogging or scaling prevention, without limitation.

In this specification, the terms ‘comprises’, ‘comprising’, ‘includes’, ‘including’, ‘having’, ‘has’, or similar terms are intended to mean a non-exclusive inclusion, such that a method, system or apparatus having an inclusion of a list of elements may not necessarily include those elements solely, but may also include other elements not listed.

### LIST OF REFERENCE IDENTIFIERS

1 Flotation system, circuit, island, process, assembly, or apparatus
2 Incoming feed slurry
3 Pulping tank for incoming feed slurry
4 Diluted incoming feed slurry
5 Pump
6 Second flow meter
7 Density meter
8 Sparger
9 Dilution water
10 First flow meter
11 First control valve
12 Bus and/or network (e.g., wired or wireless)
13 Sparger water
14 Third flow meter
15 Second control valve
16 First check valve
17 Flotation reagent
18 Fourth flow meter
19 Third control valve
20 Second check valve
21 Sparger air/gas
22 Fifth flow meter
23 Fourth control valve
24 Third check valve
25 Mixer
26 Fourth check valve
27 Aerated fluid (comprising sparger water, reagent, and sparger air/gas)
28 Distributed control system (DCS) (e.g., including integrated network and CPU)
29 Reagentized aerated slurry
30 Flotation apparatus
31 Tube comprising a flexible perforated membrane
32 Main separation chamber
33 Lamella section
34 Lamella plates/inclined plate stack
35 Lower outlet
36 Wash water introduction means
37 Perforated plate
38 Lower section
39 Upper outlet
40 Upper flange
41 Upper housing
42 Upper intake port(s)
43 Upper intake conduit(s) (for receiving incoming feed slurry 2)
44 Upper flanged connection(s)
45 Sparging mix conduit(s) or chamber(s)
46 Lower flanged connection(s)
47 Lower intake conduit(s) (for conveying reagentized aerated slurry 29)
48 Lower connection flange (connecting lower housing 60 to middle housing 55)
49 Lower outlet port(s)
50 Upper chamber
51 Middle chamber
52 Lower chamber
53 Lower flow diverter
54 Lower flange
55 Middle housing
56 Upper connection flange (connecting upper housing 41 to middle housing 55)
57 Upper flow diverter
58 Upper closed end
59 Inlet opening (for receiving aerated fluid 27)
60 Lower housing
61 First sacrificial replaceable wear element
62 Second sacrificial replaceable wear element
63 Downcomber
64 Manifold

What is claimed is:

1. A flotation circuit (1) comprising:
a flotation apparatus (30) comprising feed introduction means, the feed introduction means being configured to deliver feed material (4) into a main separation chamber (32) of the flotation apparatus (30); wherein particles of the feed material entering the main separation chamber (32) end up leaving the flotation apparatus (30) through an upper outlet (39) of the flotation apparatus (30) or through a lower outlet (39) of the flotation apparatus (30), CHARACTERISED IN THAT
the flotation circuit (1) comprises a sparger (8) having a sparging mix conduit or chamber (45); and a tube (31) comprising a flexible perforated membrane disposed within the sparging mix conduit or chamber (45); the tube (31) comprising a flexible perforated membrane being configured to:
i) receive an aerated fluid (27) comprising a combination of sparger water (13), reagent (17), and sparger air or gas (21) therein,
ii) shear said aerated fluid (27) upon passing of the aerated fluid (27) through the flexible perforated membrane of the tube (31), and
iii) disperse sheared aerated fluid (27) into the sparging mix conduit or chamber (45) such that the sheared aerated fluid (27) combines with the feed material (4) moving within the sparging mix conduit or chamber (45);
wherein reagentized aerated slurry (29) comprising a combination of i) the incoming feed material (4) and ii) sheared aerated fluid (27) is introduced to the main separation chamber (32) of the flotation apparatus (30).

2. The flotation circuit (1) according to claim 1, wherein the tube (31) of the sparger (8) is configured as one of the group consisting of: a straight tube, a curved tube, a coil, a disc, a puck, a panel, and a plate.

3. The flotation circuit (1) according to any one of the preceding claims, wherein the sparger (8) comprises a plurality of sparging mix conduits or chambers (45) each having a tube (31) comprising a flexible perforated membrane therein.

4. The flotation circuit (1) according to any one of the preceding claims, comprising a source of the sparger water (13), a source of the reagent (17), and a source of the sparger air or gas (21).

5. The flotation circuit (1) according to claim 4, wherein each source is accompanied by its own flow meter (14, 18, 22) and control valve (15, 19, 23) to control and/or adjust relative amounts of sparger water (13), reagent (17), and sparger air or gas (21) entering a mixer (25) before the aerated fluid (27) is introduced to the sparger (8).

6. The flotation circuit (1) according to claim 5, wherein the mixer (25) is configured to feed the aerated fluid (27) to an inner portion of the tube (31) of the sparger (8).

7. The flotation circuit (1) according to claim 5, wherein each flow meter (14, 18, 22) and control valve (15, 19, 23) is configured to communicate with a distributed control system (DCS) (25) over a bus or network (12).

8. The flotation circuit (1) according to any of the preceding claims, wherein the tube (31) is disposed within the sparging mix conduit or chamber (45).

9. The flotation circuit (1) according to any of the preceding claims, further comprising a pulping tank (3) for diluting incoming feed slurry (2) and delivering diluted incoming feed slurry (4) as the feed material provided to the sparger (8).

10. The flotation circuit (1) according to claim 9, further comprising a source of dilution water (9), a flow meter (10) downstream of the source of dilution water (9), and control valve (11) downstream of the source of dilution water (9) which controls and/or adjusts the amount of the dilution water (9) being provided to the pulping tank (3).

11. The flotation circuit (1) according to claim 10, wherein the flow meter (10) and control valve (11) are configured to communicate with a distributed control system (DCS) (25) over a bus or network (12); wherein the distributed control system (DCS) (25) is configured to control and/or adjust the amount of dilution water (9) being added to the incoming feed slurry (2) in a manner which compensates for an amount of the sparger water (13) being introduced to the sparger (8) via the aerated fluid (28) and/or in a manner which ensures proper water balance of the reagentized aerated slurry (29) introduced to the flotation apparatus (30).

12. The flotation circuit (1) according to any of the preceding claims, wherein the sparger (8) comprises a plurality of said tube (31) within the sparging mix conduit or chamber (45).

13. The flotation circuit (1) according to any of the preceding claims, wherein the flotation apparatus (30) comprises a column flotation cell, or, a flotation cell comprising a lamella section (33) and which is capable of forming an inverted fluidized bed within the main separation chamber (32).

14. The flotation circuit (1) according to any of the preceding claims, wherein the flotation apparatus (30) comprises the sparger (8).

15. The flotation circuit (1) according to any of the preceding claims, wherein the sparger (8) is provided upstream of the flotation apparatus (30).

16. A method for performing flotation comprising the steps of:
providing the flotation circuit (1) according to any one of the preceding claims;
conveying the feed material (4) through the sparging mix conduit or chamber (45) of the sparger (8);
mixing (25) an amount of the sparger water (13), reagent (17), and sparger air or gas (21) to form the aerated fluid (27);
delivering the aerated fluid (27) to the tube (31);
shearing the aerated fluid (27) by virtue of passing the aerated fluid (27) through the flexible perforated membrane of the tube (31) and into the sparging mix conduit or chamber (45);
combining the sheared aerated fluid (27) and feed material (4) in the sparging mix conduit or chamber (45) to form a reagentized aerated slurry (29);
introducing the reagentized aerated slurry (29) to the main separation chamber (32) of the flotation apparatus (30).

17. The method according to claim 14, further comprising the steps of:
diluting incoming feed slurry (2) in a pulping tank (3) to form a diluted incoming feed slurry (4); and
conveying the diluted incoming feed slurry (4) to the sparger (8).
